(19) United States
(12) Patent Application Publication
(10) Pub. No.: US 2012/0263431 A1
(43) Pub. Date: Oct. 18, 2012

(54) VIDEO CONTENT REPRODUCTION APPARATUS AND METHOD OF DISPLAYING CONTENT INFORMATION

(76) Inventors: Akihiro Ebina, Kyoto (JP); Seiji Kubo, Osaka (JP); Atsuhiro Tsuji, Osaka (JP); Taku Matsuda, Nara (JP)

(21) Appl. No.: 13/318,673

(22) PCT Filed: May 31, 2011
(86) PCT No.: PCT/JP2011/003021

§ 371 Date: Nov. 3, 2011

(30) Foreign Application Priority Data
Jun. 1, 2010 (JP) 2010-126360

(51) Int. Cl. H04N 5/775

(52) U.S. Cl. 386/230; 386/E05.07

(57) ABSTRACT

When an instruction receiving unit (620) receives an information display instruction to display information on a video that is not being reproduced (hereinafter referred to as video content not being reproduced) which is a video different from a video that is being reproduced, a control unit (630) causes a display device to display information on video content not being reproduced which is all or part of the video content not being reproduced and can be reproduced by a reproduction unit (610) within a duration of an unreproduced portion of the video that is being reproduced.

### TECHNICAL FIELD

The present invention relates to a video content reproduction apparatus which performs a process during reproduction of video content and to a method of displaying content information.

### BACKGROUND ART

In recent years, along with digitalization of airwave broadcasting, more diverse broadcast content has been provided. On the other hand, more and more video content distribution services have become available such as Internet Protocol (IP) broadcasting and Video On Demand (VOD) with spread of Fiber To The Home (FTTH), so that we users can enjoy an enormous number of videos (programs).

In view of this, new techniques for searching, among such a large number of videos (programs), for video content (a program) which meets preferences of users of video content reproduction apparatuses have been actively developed.

PTL 1 discloses a technique in which a keyword is extracted as a user's preference information from data on television programs on a channel chosen by the user, and a recommendable program (video content) which suits the user's preference is selected based on statistics for the keyword (this technique is hereinafter referred to as a conventional technique A).

### CITATION LIST

### Patent Literature

[PTL 1] Japanese Unexamined Patent Application Publication Number 11-164217

### SUMMARY OF INVENTION

### Technical Problem

However, when a user loses interest in video content being reproduced, it is impossible to obtain information on video content using the conventional technique A in order to allow the user to make effective use of the time corresponding to the duration of the unreproduced portion of the video content being reproduced.

In other words, there is a problem that it is impossible to obtain, using the conventional technique A, information on video content appropriate for the duration of the unreproduced portion of the video content being reproduced (hereinafter referred to as an unreproduced portion duration).

The present invention, conceived to address the problem, has an object of providing a video reproduction apparatus capable of displaying information on video content appropriate for the unreproduced portion duration of video content being reproduced, and a method of displaying the information on the appropriate video content.

### Solution to Problem

In order to solve the problem, a video content reproduction apparatus according to an aspect of the present invention operates in conjunction with a display device. The video content reproduction apparatus includes: a reproduction unit configured to reproduce a video; an instruction receiving unit configured to receive an instruction; and a control unit configured to control the video content reproduction apparatus, wherein, when the instruction receiving unit receives an information display instruction to display information on a video that is not being reproduced (hereinafter referred to as video content not being reproduced) which is a video different from a video that is being reproduced (hereinafter referred to as video content being reproduced), the control unit is configured to cause the display device to display information on video content not being reproduced which is all or part of the video content not being reproduced and can be reproduced by the reproduction unit within a remaining duration of the video content being reproduced, the remaining duration being a duration of an unreproduced portion of the video content being reproduced.

In other words, when the instruction receiving unit receives an information display instruction to display information on a video that is not being reproduced (hereinafter referred to as video content not being reproduced) which is a video different from a video that is being reproduced (hereinafter referred to as video content being reproduced), the video content reproduction apparatus causes the display device to display information on video content not being reproduced which is all or part of the video content not being reproduced and can be reproduced by the reproduction unit within a duration of an unreproduced portion of the video content being reproduced (remaining duration).

Still in other words, when the instruction receiving unit receives an information display instruction to display information on a video content not being reproduced, the video content reproduction apparatus causes the display device to display information on video content not being reproduced which is all or part of the video content not being reproduced and can be reproduced by the reproduction unit within a duration of an unreproduced portion of the video content being reproduced (remaining duration).

For example, it is assumed that a user viewing a video wants to view another video and thus perform an operation to issue an instruction to cause information on another video to be displayed. In this case, in the aspect of the present invention, the display unit displays information on video content not being reproduced which is all or part of the video content not being reproduced and can be reproduced by the reproduction unit within the duration of the unreproduced portion of the video content being reproduced (remaining duration).

In other words, in the aspect of the present invention, it is possible to display information on video content not being reproduced which is all or part of the video content not being reproduced and can be reproduced by the reproduction unit within the duration of the unreproduced portion of the video content being reproduced (remaining duration). That is, in the aspect of the present invention, it is possible to display information on video content appropriate for the unreproduced portion duration of a video content that is being reproduced.

Furthermore, when the instruction receiving unit receives the information display instruction, the control unit is preferably configured to search in information on the video content not being reproduced for information on video content not being reproduced which has a duration not longer than the remaining duration, and cause the display device to display the information obtained by the searching.

Furthermore, the information obtained by the control unit by searching in the information on the video content not being reproduced is preferably on video content not being reproduced which has a duration not longer than the remaining duration and suits a preference of a user.

Furthermore, when the control unit causes the display device to display the information on video content not being reproduced and the video content not being reproduced is to be entirely reproduced within the remaining duration and has a duration longer than the remaining duration (hereinafter the information is referred to as shortened-video-content information), the control unit is preferably configured to associate the shortened-video-content information with information on a reproduction speed at which the video content not being reproduced is entirely reproduced within the remaining duration, and cause the display device to display the shortened-video-content information and the information on the reproduction speed.

Furthermore, the control unit is preferably configured to update the remaining duration after the video content being reproduced has been reproduced by the reproduction unit for a predetermined time, and when the instruction receiving unit receives the information display instruction, the control unit is configured to cause the display device to display information on video content not being reproduced which is all or part of all the video content not being reproduced and can be reproduced by the reproduction unit within the updated remaining duration of the video content being reproduced.

Furthermore, the part of the video content not being reproduced preferably includes a plurality of videos.

A video content reproduction apparatus according to another aspect of the present invention operates in conjunction with a display device which reproduces a video. The video content reproduction apparatus includes: a reproduction unit configured to reproduce a video; an instruction receiving unit configured to receive an instruction; and a control unit configured to control the video content reproduction apparatus, wherein, when the instruction receiving unit receives an information display instruction to display information on a video that is not being reproduced (hereinafter referred to as video content not being reproduced) which is a video different from a video that is being reproduced by the display device (hereinafter referred to as video content being reproduced), the control unit is configured to cause the display device to display information on video content not being reproduced which is all or part of the video content not being reproduced and can be reproduced by the reproduction unit within a remaining duration of the video content being reproduced, the remaining duration being a duration of an unreproduced portion of the video content being reproduced.

A video content reproduction apparatus according to another aspect of the present invention includes: a display unit configured to display a video; a reproduction unit configured to reproduce a video; an instruction receiving unit configured to receive an instruction; and a control unit configured to control the video content reproduction apparatus, wherein, when the instruction receiving unit receives an information display instruction to display information on a video that is not being reproduced (hereinafter referred to as video content not being reproduced) which is a video different from a video that is being reproduced (hereinafter referred to as video content being reproduced), the control unit is configured to cause the display unit to display information on video content not being reproduced which is all or part of the video content not being reproduced and can be reproduced by the reproduction unit within a remaining duration of the video content being reproduced, the remaining duration being a duration of an unreproduced portion of the video content being reproduced.

A method of displaying content information according to an aspect of the present invention is performed by a video content reproduction apparatus which operates in conjunction with a display device. The video content reproduction apparatus includes: a reproduction unit configured to reproduce a video; and an instruction receiving unit configured to receive an instruction, and the method includes: when the instruction receiving unit receives an information display instruction to display information on a video that is not being reproduced (hereinafter referred to as video content not being reproduced) which is a video different from a video that is being reproduced (hereinafter referred to as video content being reproduced), causing the display device to display information on video content not being reproduced which is all or part of the video content not being reproduced and can be reproduced by the reproduction unit within a remaining duration of the video content being reproduced, the remaining duration being a duration of an unreproduced portion of the video content being reproduced.

The present invention may be embodied as a system large-scale integration (LSI) in which all or part of the constituent elements of the video content reproduction apparatus are implemented.

The present invention may also be embodied as a program which causes a computer to execute the steps included in the method of displaying content information. The present invention may also be embodied as a computer-readable recording medium on which the program is recorded. The program may also be distributed through a transmission medium such as the Internet.

### Advantageous Effects of Invention

According to the present invention, information on video content appropriate for an unreproduced portion duration of video content being reproduced can be displayed.

### BRIEF DESCRIPTION OF DRAWINGS

FIG. 1 is a block diagram illustrating a configuration of a video content reproduction apparatus.

FIG. 2 shows examples of the program information on broadcast content.

FIG. 3 shows examples of the content information on network content.

FIG. 4 shows an example of a preference information database.

FIG. 5 shows an example of reproduction information.

FIG. 6 is a flowchart of a recommendable-content information display process.

FIG. 7 shows an example of a recommendation information image.

FIG. 8 is a flowchart of a recommendable-content information display process A.

FIG. 9 is a block diagram illustrating another configuration of the video content reproduction apparatus.

FIG. 10 is a block diagram illustrating a functional configuration characteristic to the video content reproduction apparatus.

### DESCRIPTION OF EMBODIMENTS

Embodiments of the present invention are described below with reference to the drawings. In the following, like reference numerals refer to like parts. The like parts have an identical name and identical functions. Thus, a detailed description thereof is not repeated here.

### Embodiment 1

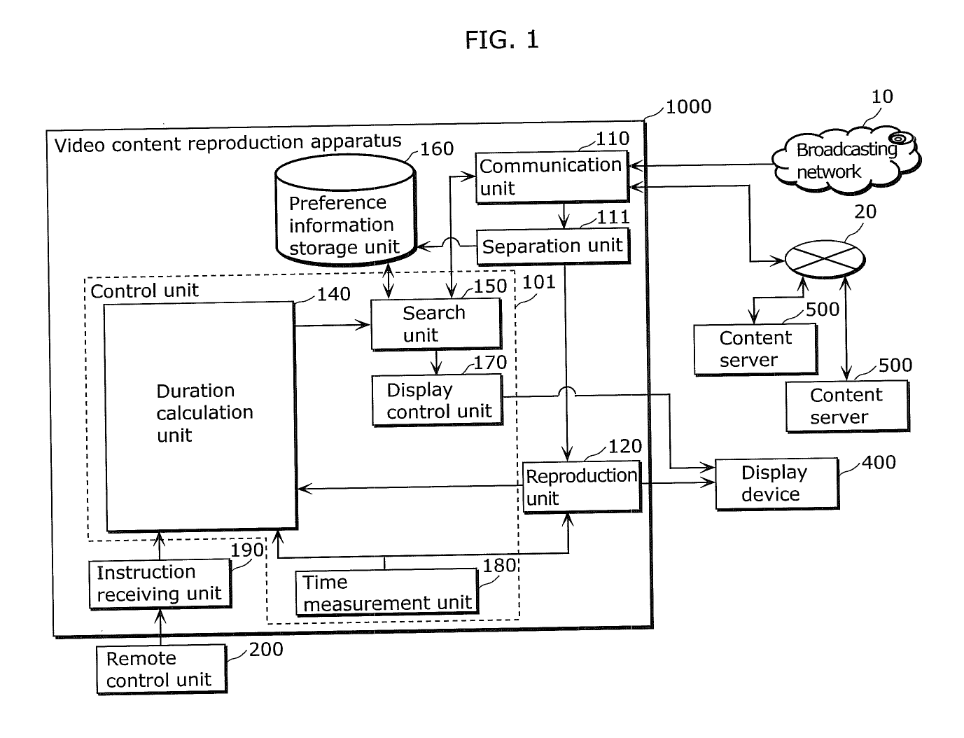

FIG. 1 is a block diagram illustrating a configuration of a video content reproduction apparatus 1000. It is to be noted that FIG. 1 shows a remote control unit 200, a display device 400, and a plurality of content servers 500 only for illustrative purposes, and they are not included in the video content reproduction apparatus 1000.

The display device 400 includes a liquid crystal display (LCD) panel. The display device 400 may include a panel of a different display system instead.

The video content reproduction apparatus 1000 is capable of reproducing a video. Examples of the video content reproduction apparatus 1000 include a hard disk drive (HDD) recorder. The video content reproduction apparatus 1000 is not limited to a hard disk drive (HDD) recorder and may be an apparatus of a different type, such as a set-top box (STB) or a personal computer (PC).

The video content reproduction apparatus 1000 may include the display device 400. In this case, the video content reproduction apparatus 1000 may be an apparatus such as a television receiver or a mobile phone.

In other words, the video content reproduction apparatus 1000 may be any apparatus which is capable of receiving a video through communications, and reproducing the video.

The video content reproduction apparatus 1000 has a function of reproducing a video at a speed k (k is a positive number larger than one) times faster than a normal speed (an original speed) in addition to a function of reproducing a video at the normal speed.

In the present description, video content includes video and audio. Video content may include only video.

The video content reproduction apparatus 1000 receives a broadcast stream transmitted from a broadcasting station not shown in the drawings through a broadcasting network 10. That is, the broadcasting network 10 provides a broadcast stream using radio waves (broadcasting waves). The broadcast stream contains video content and program information described later. The program information is information on the video content which is a program.

Hereinafter, video content contained in a broadcast stream is also referred to as broadcast content.

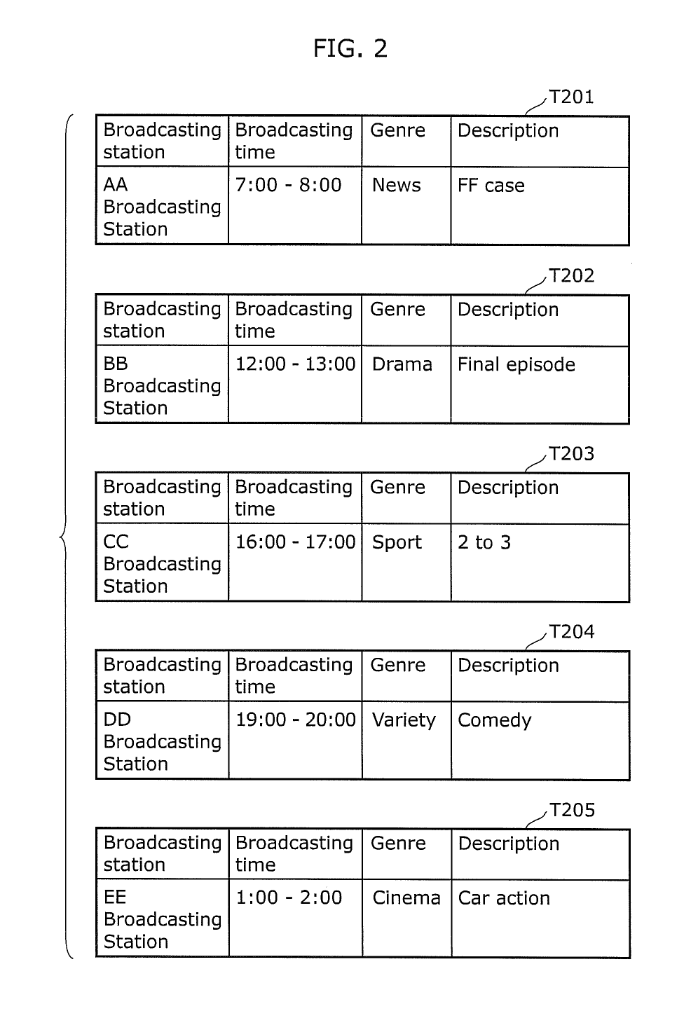

FIG. 2 shows examples of the program information on broadcast content.

The program information on broadcast content may be indicated by meta data contained in a broadcast stream.

Referring to FIG. 2, program information T201, T202, T203, T204, and T205 are each associated with respective programs (videos).

For example, in the program information T201, “Broadcasting station” indicates the name of a broadcast station which distributes a video as a program. “Broadcasting time” indicates the broadcasting time for the program. “Genre” indicates the genre of the program (video). “Description” indicates detailed information of the program (video). The “Description” shows the title of the program (video), the name of the program, casts, and details of the program in text.

Specifically, the program information T201 shows that the program (video) associated with the program information T201 is distributed by the AA Broadcasting Station from 7:00 to 8:00, and ends at 8:00.

The program information T201 also shows that the program associated with the program information T201 belongs to the genre of news and features an FF case.

The program information T202, T203, T204, and T205 are similar to the program information T201, and therefore the detailed description thereof is not repeated.

Referring to FIG. 1 again, the video content reproduction apparatus 1000 is configured so as to be capable of communicating with a communication network 20. The communication network 20 is a network such as the Internet. The communication network 20 may include a telephone network, an asymmetric digital subscriber line (ADSL), and an optical fiber network.

Each of the content servers 500 is, for example, a Video-On-Demand (VOD) server. The content servers 500 store videos and items of content information associated with the respective videos. Each item of the content information indicates information on the associated video (for example, title, genre, and duration).

The content servers 500 are not limited to VOD servers and may be any type of servers which are capable of transmitting a video through the communication network 20.

The video content reproduction apparatus 1000 receives a network stream distributed from the content servers 500 through the communication network 20. The network stream contains video content and content information.

The content information is information on network content. Hereinafter, video content contained in a network stream is also referred to as network content.

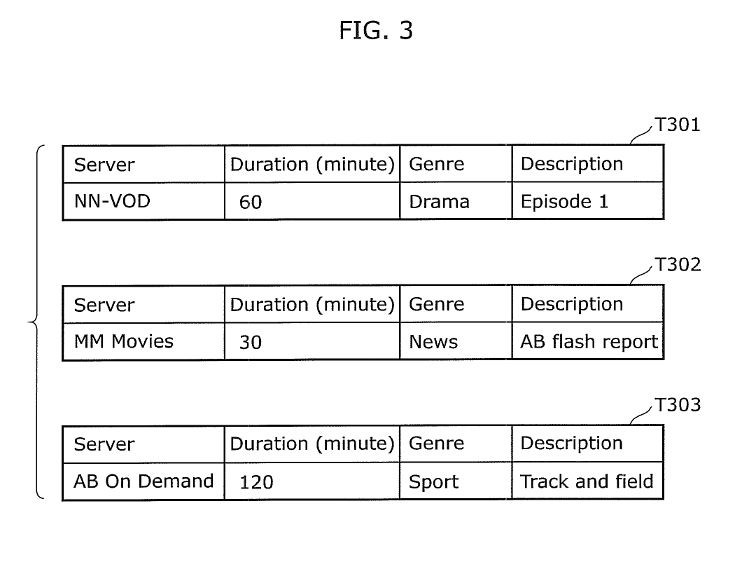

FIG. 3 shows examples of the content information on network content. The content information on network content is represented in a structured language such as HTML or XML.

Referring to FIG. 3, content information T301, T302, and T303 are each associated with corresponding network content.

For example, in the content information T301, “Server” indicates the name of a server which distributes corresponding network content. “Duration” indicates a duration of corresponding network content. In other words, a duration is time necessary for reproducing the whole of a video to be reproduced. “Genre” indicates the genre of corresponding network content. “Description” indicates detailed information of corresponding network content. The “Description” shows the title, casts, and details of corresponding network content in text.

For example, the content information T301 shows that the network content associated with the content information T301 is distributed by the NN-VOD Server, and the duration of the network content is 60 minutes.

The content information T301 also shows that the network content associated with the content information T201 belongs to the genre of drama and is the first episode of the drama.

The content information T302 and T303 are similar to the content information T301, and therefore the detailed description thereof is not repeated.

Each of the broadcast stream and the network stream is, for example, a transport stream in accordance with the MPEG-2 standard. Alternatively, each of the broadcast stream and the network stream may be a transport stream in accordance with a standard other than the MPEG-2 standard.

Hereinafter, the broadcast stream and the network stream are collectively also referred to as streams.

For example, the broadcast content is coded using a coding method in accordance with the standard of MPEG-2 TS (Transport Stream). Alternatively, the broadcast content may be coded using a coding method other than the method in accordance with the standard of MPEG-2 TS.

The network content is, for example, VOD content. The network content is coded using, for example, a coding method in accordance with the standard of MPEG-2 TS.

Referring to FIG. 1 again, the video content reproduction apparatus 1000 includes a communication unit 110, a separation unit 111, a reproduction unit 120, a control unit 101, a preference information storage unit 160, and an instruction receiving unit 190.

The control unit 101 includes a duration calculation unit 140, a search unit 150, a display control unit 170, and a time measurement unit 180.

The control unit 101 controls the video content reproduction apparatus. The control unit 101 is a piece of hardware such as a central processing unit (CPU). All or part of the duration calculation unit 140, the search unit 150, the display control unit 170, and the time measurement unit 180 may be implemented in hardware.

The control unit 101 may be a module of a program to be executed by a CPU or the like. In this case, all or part of the duration calculation unit 140, the search unit 150, the display control unit 170, and the time measurement unit 180 may be a module of a program to be executed by a CPU or the like.

The preference information storage unit 160 is a storage medium capable of non-volatile data storage. The preference information storage unit 160 is, for example, an HDD, a flash memory, or an EEPROM.

The communication unit 110 has a function of receiving a broadcast stream transmitted from a broadcasting station not shown in the drawings through the broadcasting network 10. The communication unit 110 has a function of communicating with the communication network 20.

The communication unit 110 receives a stream (a broadcast stream or a network stream) from the broadcasting network 10 or the communication network 20.

The communication unit 110 transfers the received stream (the broadcast stream or the network stream) to the separation unit 111.

When receiving the broadcast stream, the separation unit 111 transmits, to the reproduction unit 120, video content (broadcast content) contained in the broadcast stream and the broadcasting time indicated by the program information contained in the broadcast stream, and stores the program information contained in the broadcast stream in the preference information storage unit 160 as preference information indicating a preference of a user.

When receiving the network stream, the separation unit 111 transmits, to the reproduction unit 120, video content (network content) contained in the network stream and the duration indicated by the content information contained in the network stream, and stores the content information contained in the network stream in the preference information storage unit 160 as preference information indicating a preference of a user.

The preference information stored in the preference information storage unit 160 forms preference information database DB400 in the preference information storage unit 160. The formation of the preference information database DB400 will be described later.

Hereinafter, the broadcasting time and the duration are also collectively referred to as reproduction-related time.

The reproduction unit 120 decodes the received video content using a decoding method corresponding to the coding method used with the video content. Specifically, the reproduction unit 120 performs a content decoding and reproducing process in which the reproduction unit 120 decodes the video content in a predetermined unit according to the standard of MPEG-2 TS, for example. The reproduction unit 120 thereby reproduces a video.

The predetermined unit is, for example, one group of pictures (GOP). The reproduction unit 120 obtains video data by decoding video content in the predetermined unit.

Each time the reproduction unit 120 obtains video data by decoding, the reproduction unit 120 transmits the obtained video data to the display device 400.

The display device 400 displays a video based on the received video data.

The reproduction unit 120 repeats the process of decoding the video content in the predetermined unit until the whole of the video content is completely decoded.

A video is thus reproduced by the content decoding and reproducing process.

That is, the video content reproduction apparatus 1000 operates in conjunction with the display device 400.

Hereinafter, a video that is being reproduced by the reproduction unit 120 is referred to as video content being reproduced.

In addition, the reproduction unit 120 generates reproduction information using the reproduction-related time (the broadcasting time or the duration) received from the separation unit 111 and holds the reproduction information. The reproduction information will be described later.

The following describes the preference information database DB400.

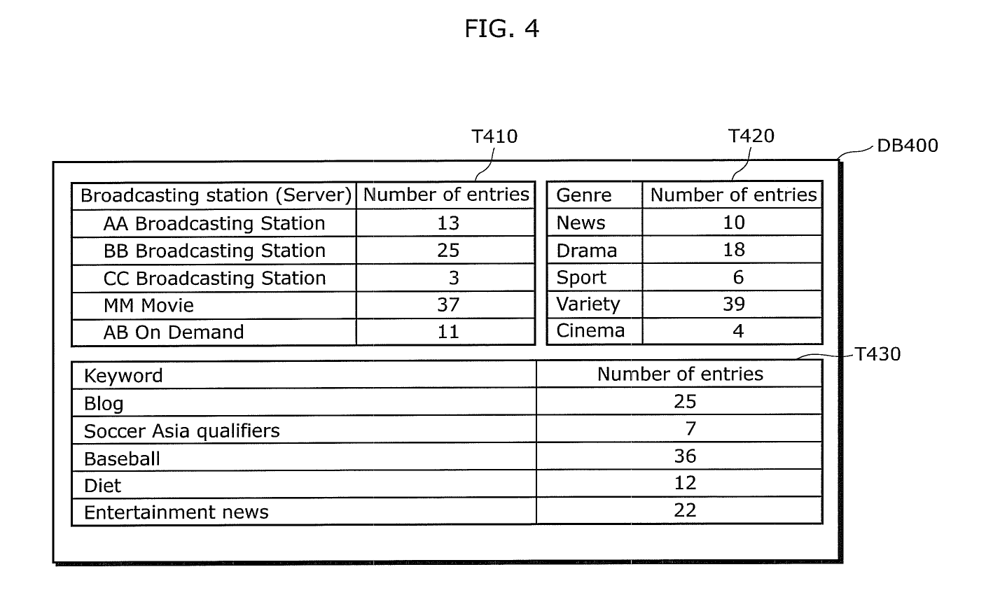

FIG. 4 shows an example of the preference information database DB400.

Referring to FIG. 4, the preference information database DB400 includes preference information data tables T410, T420, and T430.

The preference information data table T410 lists the broadcast stations and the servers which have distributed the videos reproduced by the reproduction unit 120. In the preference information data table T410, “Number of entries” indicates the numbers of entries (appearances) of the broadcast stations and the servers listed therein in the items of the program information or the content information associated with the videos reproduced by the reproduction unit 120. That is, the number of entries shown in the preference information data table T410 indicates a preference of a user.

For example, the preference information data table T410 indicates that the video distributed by the broadcasting station of the AA Broadcasting Station has been reproduced 13 times.

The preference information data table T420 lists the genres of the videos reproduced by the reproduction unit 120. In the preference information data table T420, the “Number of entries” indicates the numbers of entries (appearances) of the genres listed therein in the text in the items of the program information or the content information associated with the videos reproduced by the reproduction unit 120.

For example, the preference information data table T420 indicates that the video which belongs to the genre of variety has been reproduced most frequently, that is, 39 times. In other words, the user who views videos using the video content reproduction apparatus 1000 prefers videos which belong to the genre of variety. That is, the number of entries shown in the preference information data table T420 indicates a preference of the user.

The preference information data table T430 lists the keywords of the program information and the content information associated with the videos reproduced by the reproduction unit 120. In the preference information data table T430, the “Number of entries” indicates the numbers of entries (appearances) of the keywords listed therein in the text in the items of the program information or the content information associated with the videos reproduced by the reproduction unit 120. That is, the number of entries shown in the preference information data table T430 indicates a preference of the user.

When the reproduction unit 120 reproduces a video, the preference information database DB400 is updated by the separation unit 111 based on program information or content information obtained by the separation unit 111.

Here, by way of example, it is assumed that the separation unit 111 receives program information T201 and a video associated with the program information T201. In this case, the separation unit 111 increments the number of entries for the “AA Broadcasting Station” in the preference information data table T410 included in the preference information database DB400 by one, and increments the number of entries for “News” in the preference information data table T420 by one. The separation unit 111 also extracts a keyword from the “Description” in the program information T201. Then, the separation unit 111 increments the number of entries for the extracted keyword by one.

This shows that a larger number of entries for each item of the broadcasting station (server), genre, and keyword in the preference information data tables T410, T420, and T430, respectively, indicates that the user has viewed the video with a stronger preference.

Referring to FIG. 1 again, the duration calculation unit 140 calculates the duration of the unreproduced portion of the video content being reproduced (remaining duration). The process of the calculation will be detailed later. Hereinafter, a duration of an unreproduced portion of video content being reproduced is also referred to as an unreproduced portion duration. That is, a remaining duration is an unreproduced portion duration.

The search unit 150 searches for a video by making use of the preference information stored in the preference information storage unit 160. The process of searching will be described later. The search unit 150 also generates, based on the information on the video obtained by the searching, an image showing a list of content information. The process of generating the image will be described later.

The display control unit 170 causes the display device 400 to display the image generated by the search unit 150. The process of displaying the image will be described later.

The time measurement unit 180 measures the current time. The time measurement unit 180 notifies the reproduction unit 120 and the duration calculation unit 140 of the latest current time upon each change in the current time. The time measurement unit 180 may also obtain the current time from a time server via the communication network 20.

The instruction receiving unit 190 receives a control signal wirelessly transmitted from the remote control unit 200. Upon receiving the control signal, the instruction receiving unit 190 notifies the duration calculation unit 140 of the receiving of the control signal. The remote control unit 200 is a remote control which allows remote operation of the video content reproduction apparatus 1000. The remote control unit 200 includes buttons for controlling the video content reproduction apparatus 1000. The buttons are not shown in the drawings. When a user presses one of the buttons, the remote control unit 200 controls the video content reproduction apparatus 1000 by transmitting a control signal corresponding to the pressed button to the instruction receiving unit 190.

Hereinafter, a user's operation of the buttons included in the remote control unit 200 is referred to as a user operation M.

Optionally, a button accessible for a user may be provided outside the video content reproduction apparatus 1000. In this case, the instruction receiving unit 190 may receive a control signal corresponding to the button upon an operation on the button by a user.

The reproduction unit 120 generates reproduction information while reproducing a video, and holds the reproduction information as describe above.

Here, by way of example, it is assumed that the separation unit 111 receives the program information T201 shown in FIG. 2 and a video (broadcast content) associated with the program information T201.

In this case, the separation unit 111 updates the preference information in the preference information database DB400 and transmits the video (broadcast content) and the broadcasting time indicated in the program information T201 (7:00-8:00) to the reproduction unit 120 as described above.

The reproduction unit 120 reproduces the received video (broadcast content) by the content decoding and reproducing process described above, and generates reproduction information T450 based on the received broadcasting time (7:00-8:00).

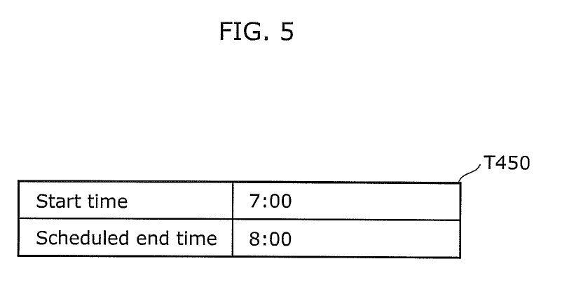

FIG. 5 shows an example of the reproduction information T450.

In the reproduction information T450, “Start time” indicates a time for starting broadcast of video content being reproduced. “Scheduled end time” indicates a time at which broadcast of video content being reproduced is scheduled to end.

The reproduction information T450 may also include “Current time”. In this case, the reproduction unit 120 enters the latest current time transmitted from the time measurement unit 180 in the reproduction information T450.

The following describes specific processes performed when the separation unit 111 receives network content and content information. Upon receiving content information indicating a duration, the separation unit 111 transmits the duration to the reproduction unit 120.

The reproduction unit 120 generates reproduction information by setting the “Start time” in the reproduction information T450 to the time at which reproduction of the network content associated with the content information is started, and setting “Scheduled end time” to the time calculated by adding the duration to the “Start time”. Reproduction information is thus generated also in the case of reproduction of network content. The “Scheduled end time” indicated in the resulting reproduction information is a time at which the reproduction of the network content is scheduled to end.

The process is illustrated by the following example. Here, by way of example, it is assumed that the separation unit 111 receives the content information T301 shown in FIG. 3 and a video (network content) associated with the content information T301.

In this case, the separation unit 111 updates the preference information in the preference information database DB400 and transmits the network content and the duration (60 minutes) indicated in the content information T301 to the reproduction unit 120 as described above.

The reproduction unit 120 generates reproduction information by setting the “Start time” in the reproduction information T450 to the time at which reproduction of the network content is started, and setting “Scheduled end time” in the reproduction information T450 to the time calculated by adding 60 minutes to the “Start time”. The reproduction unit 120 holds the resulting reproduction information.

The reproduction unit 120 continually updates the reproduction information when the reproduction unit 120 receives content information not indicating fixed “Start time” and “Scheduled end time”, such as network content information. For example, when 10 minutes has elapsed since the generation of reproduction information, the reproduction unit 120 updates “Scheduled end time” currently indicated in the reproduction information to a time 10 minutes ahead thereof. The reproduction unit 120 also updates the “Start time” to “Current time”, that is, the time 10 minutes after the generation of the reproduction information.

The following describes a process for displaying information on a video while another video is being reproduced (hereinafter referred to as a recommendable-content information display process). The recommendable-content information display process is performed while the reproduction unit 120 is reproducing a video.

Here, it is assumed that the video content reproduction apparatus 1000 is reproducing a video and a user is viewing the video displayed on the display device 400.

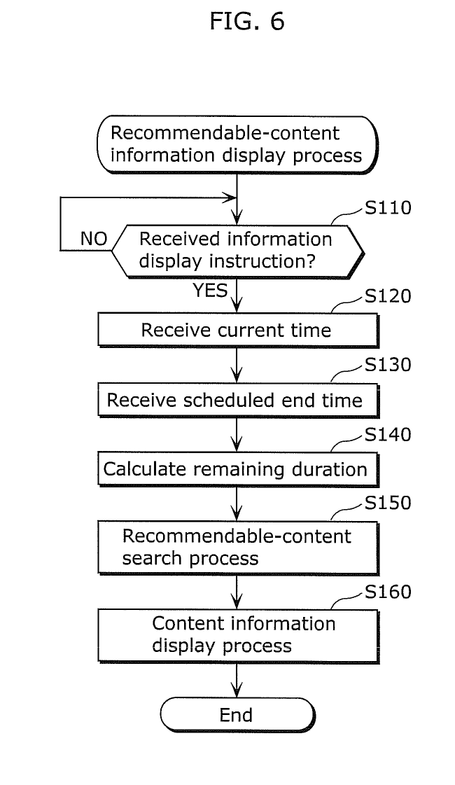

FIG. 6 is a flowchart of the recommendable-content information display process.

In Step S110, the duration calculation unit 140 determines whether or not the instruction receiving unit 190 receives an information display instruction during reproduction of the video. The information display instruction is an instruction to display information on a video which is different from the video that is being reproduced (hereinafter referred to as video content not being reproduced). The information display instruction is included in a control signal transmitted from the remote control unit 200 upon a user operation M.

Specifically, the duration calculation unit 140 determines whether or not the instruction receiving unit 190 has received a control signal indicating an information display instruction. Hereinafter, a user operation M performed on the remote control unit 200 in order to transmit a control signal indicating an information display instruction from the remote control unit 200 is also referred to as an information display instruction operation.

The instruction receiving unit 190 receives an information display instruction when, for example, the user is not interested in the video that is being reproduced by the video content reproduction apparatus 1000 and therefore wants the video content reproduction apparatus 1000 to reproduce another video.

Hereinafter, a period of time set aside by the user for viewing the video that is being reproduced by the video content reproduction apparatus 1000 is referred to as a content viewing time. For example, when the duration of the video is 60 minutes, the user sets aside a content viewing time of 60 minutes.

For example, in the case where the video associated with the program information T201 in FIG. 2 is being reproduced by the video content reproduction apparatus 1000, the content viewing time set aside by the user is 60 minutes.

For example, in the case where the video associated with the content information T301 in FIG. 3 is being reproduced by the video content reproduction apparatus 1000, the content viewing time set aside by the user is 120 minutes.

The following describes a specific example. The user sets aside a content viewing time of two hours (120 minutes) and causes the video content reproduction apparatus 1000 to start reproduction of a video having a duration of two hours. Viewing the video having a duration of two hours, the user loses interest in the video 30 minutes after the start of the reproduction of the video and performs an information display instruction operation. Then, the instruction receiving unit 190 receives a control signal indicating the information display instruction. The instruction receiving unit 190 notifies the duration calculation unit 140 of the receiving of the control signal indicating the information display instruction. Then, the duration calculation unit 140 determines that the instruction receiving unit 190 has received the information display instruction.

When Yes in Step S110, the process proceeds to Step S120. On the other hand, when No in Step S110, the determining in Step S110 is performed again.

In Step S120, the duration calculation unit 140 receives the latest current time from the time measurement unit 180. In the case where the reproduction unit 120 holds reproduction information indicating the current time, the duration calculation unit 140 may receive the current time from the reproduction unit 120.

In Step S130, the duration calculation unit 140 receives reproduction information indicating a scheduled end time for the video content being reproduced from the time measurement unit 120. The duration calculation unit 140 thus receives the scheduled end time for the video content being reproduced.

In Step S140, the duration calculation unit 140 calculates a period of time from the received latest current time to the scheduled end time as a remaining duration. The remaining duration is a period of time necessary for reproducing the video content being reproduced from a current point that is a point of the video content being reproduced up to which the video content has been reproduced by the latest current time to the end of the video content being reproduced. In other words, the remaining duration is a duration of the unreproduced portion of the video content being reproduced.

Then, the duration calculation unit 140 notifies the search unit 150 of the calculated remaining duration.

In Step S150, a recommendable-content search process is performed. In the recommendable-content search process, the search unit 150 searches for recommendable content with reference to the preference information data table included in the preference information database stored in the preference information storage unit 160.

Here, the recommendable content is a video different from video content being reproduced (hereinafter such a video is also referred to as video content not being reproduced). The recommendable content is video content not being reproduced which is to be reproduced within the remaining duration. In other words, the recommendable content is video content not being reproduced which can be reproduced by the reproduction unit 120 within the remaining duration. The recommendable content is also video content not being reproduced which has a duration appropriate for the remaining duration and suits a preference of the user. Here, the video content not being reproduced which has a duration is video content not being reproduced which having the duration. Hereinafter, a duration appropriate for a remaining duration is also referred to as an appropriate duration.

Here, the appropriate duration is a time period not longer than the remaining duration. It is to be noted that the appropriate duration may last for a time longer than the remaining duration. The preference of the user is preference information indicated in the preference information data table included in the preference information database stored in the preference information storage unit 160.

Here, it is assumed that the preference information data table referenced by the search unit 150 is the preference information data table T420 in FIG. 4. By way of example, it is also assumed that the preference information to be used is “Variety”, which has the largest number of entries among the genres listed in the preference information data table T420. By way of example, it is also assumed that the remaining duration calculated in Step S140 is 60 minutes. It is also assumed that the appropriate duration, which is the duration of recommendable content, is not longer than the remaining duration.

In this case, the recommendable content to be searched for is a video which belongs to the video content genre of variety, and the duration of the video is not longer than 60 minutes. The search unit 150 performs a searching process A in order to search for recommendable content via the communication unit 110 among the videos (video content not being reproduced) stored in the content servers 500 connected to the communication network 20.

When the search unit 150 finds recommendable content by the searching process A, the search unit 150 requests the content server 500 storing the recommendable content for the content information of the recommendable content. The content information indicates, for example, the title, duration, and genre of the recommendable content.

Hereinafter, the content information of the recommendable content found by the searching process A is referred to as recommendable-content information.

Receiving the recommendable-content information, the content server 500 transmits the recommendable-content information to the video content reproduction apparatus 1000. The search unit 150 thus receives the recommendable-content information via the communication unit 110. In the case where the recommendable content found includes a plurality of videos, the search unit 150 receives a plurality of items of recommendable-content information.

In the case where recommendable content is not found by the searching process A, the search unit 150 changes conditions for recommendable content in order to increase the probability of finding recommendable content, and then performs the searching process A again.

For example, the search unit 150 uses more items of preference information than the item of preference information used in the previous searching process A, or sets the appropriate duration, within which recommendable content is to be reproduced, to a time longer by a predetermined time (for example, 10 minutes) than the remaining duration.

By way of example, it is assumed that more items of preference information are used. In this case, for example, the search unit 150 refers to the preference information data table T430 in addition to the preference information data tables T420. Then, the item having the largest number of entries in each of the preference information data tables T420 and T430 is used as the preference information. In this case, the genre of “Variety” and the keyword of “Baseball” are used as the preference information. The selected items of the preference information are used for, for example, a logical OR search in the new searching process A.

It is also assumed that the search unit 150 sets the appropriate duration, within which recommendable content is to be reproduced, to a time 10 minutes longer than the remaining duration. Here, it is also assumed that the remaining duration calculated in Step S140 is 60 minutes.

In this case, the recommendable content to be searched for are the recommendable content A and the recommendable content B: the recommendable content A is a video which belongs to the video content genre of “Variety”, and the duration thereof is not longer than 70 minutes; and the recommendable content B is a video which belongs to the video content genre of “Baseball”, and the duration of the video is not longer than 70 minutes. That is, each of the recommendable content A and the recommendable content B is a video which has a duration longer than the remaining duration.

In this case, the search unit 150 performs a searching process A in order to search for a recommendable content A or a recommendable content B among the videos stored in the content servers 500 connected to the communication network 20 via the communication unit 110.

When the search unit 150 finds recommendable content by the searching process A, the search unit 150 requests the content server 500 storing the recommendable content for the content information of the recommendable content as described above, so that the search unit 150 receives recommendable-content information.

The searching process A is repeatedly performed under conditions changed in order to increase the probability of finding recommendable content, until recommendable content is found.

In other words, in the recommendable-content search process, the search unit 150 searches for another video which has an appropriate duration for the remaining duration and suits a preference of the user.

The method of selecting items of the preference information to be used is not limited to the method as described above. For example, the broadcast station (server), genre, and keyword each of which having the largest number of entries may be used as the preference information. Alternatively, information obtained by weighting the numbers of entries of the listed items may be used as the preference information.

The location to be searched for recommendable content is not limited to the content servers 500. For example, a storage unit (not shown in the drawings) included in the video content reproduction apparatus 1000 and storing videos may be searched for recommendable content. An apparatus other than the content server 500 and connected to the communication network 20 may also be searched for recommendable content. In this case, the apparatus also stores videos.

Alternatively, in the searching process A, the search unit 150 may search not recommendable content but for content information of recommendable content.

The searching process A performed using varied conditions for recommendable content may be repeated a limited times. In this case, no recommendable content may be found. In this case, another process is performed such that the display device 400 displays a message such as “No recommendable item found.”

After the search unit 150 receives recommendable-content information, the following process is performed in Step S160.

In Step S160, a recommendable-content information display process is performed. In the recommendable-content information display process, the search unit 150 generates a recommendation information image which shows the one or more received items of the recommendable-content information. Next, the search unit 150 transmits the resulting recommendation information image to the display control unit 170 and provides a display instruction to the display control unit 170 to cause the display device 400 to display the recommendation information image.

The display control unit 170 follows the display instruction and causes the display device 400 to display the recommendation information image.

In other words, in the process in Step S160, the display control unit 170 causes the display device 400 to display information on a video that is not being reproduced and is appropriate for the calculated remaining duration (recommendable content). In other words, in the process in Step S160, the display control unit 170 causes the display device 400 to display information on the video (recommendable content) found as a result of the search performed by the search unit 150.

By way of example, in the process in Step S160, when the instruction receiving unit 190 receives an information display instruction, the control unit 101 including the display control unit 170 searches for information on video content not being reproduced which has a duration not longer than remaining duration, and then the control unit 101 causes the display device 400 to display the information obtained as a result of the searching. The information obtained by the searching is information on video content not being reproduced which has a duration not longer than the remaining duration and suits a preference of a user.

In still other words, in the process in Step S160, when the instruction receiving unit 190 receives an information display instruction, the control unit 101 including the display control unit 170 causes the display device 400 to display information on video content not being reproduced which is all or part of the video content not being reproduced and can be reproduced by the reproduction unit 120 within the duration of the unreproduced portion of the video content being reproduced (remaining duration).

Here, by way of example, it is assumed that the search unit 150 receives three items of recommendable-content information as a result of the process in Step S150, and that a recommendation information image G100 as described below is displayed on the display device 400.

The display device 400 simultaneously displays the recommendation information image G100 and the video content being reproduced on the display device 400 with no overlap therebetween. In this case, the video content being reproduced may be reduced in size at a given percentage.

The manner in which the display device 400 displays the recommendation information image G100 and the video content being reproduced is not limited to this, and the display device 400 may display them with an overlap therebetween.

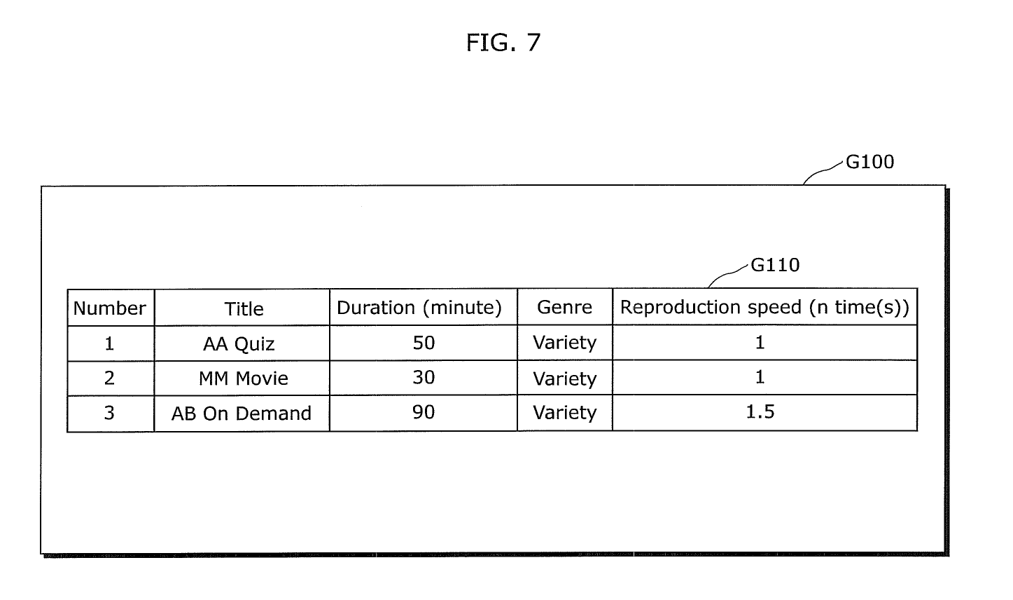

FIG. 7 shows an example of the recommendation information image G100.

Referring to FIG. 7, the recommendation information image G100 includes a recommendation information table G110. The recommendation information table G110 lists items of content information. The recommendation information table G110 indicates three items of recommendable-content information.

In the recommendation information table G110, “No.” indicates numbers each identifying a corresponding one of the items of recommendable-content information. In the recommendation information table G110, “Title” indicates the title of a corresponding video of the recommendable content. “Duration” indicates a duration of a corresponding video of the recommendable content. “Genre” indicates the genre of a corresponding video of the recommendable content. “Reproduction speed” indicates reproduction speed at which a corresponding video of the recommendable content (video content not being reproduced) can be entirely reproduced within the calculated remaining duration.

The recommendation information image G100 shows thumbnail images of the videos of the recommendable content in association with the items of the recommendable-content information listed in the recommendation information table G110. Optionally, the recommendation information image G100 may not show such thumbnail images.

In the case where the duration indicated in the recommendation information table G110 is not longer than the calculated remaining duration, the recommendable content having such a duration can be reproduced to the end at a reproduction speed as fast as an original speed, that is, a normal speed.

On the other hand, in the case where the duration indicated in the recommendation information table G110 is longer than the calculated remaining duration, the recommendable content having such a duration can be reproduced to the end at a reproduction speed k times faster than an original speed, that is, a speed faster than a normal speed (k is a positive number larger than one).

Here, it is also assumed that the calculated remaining duration is 60 minutes and that recommendable content having a duration of 90 minutes has been found by the searching process A. In this case, the reproduction speed indicated in the item of the recommendable-content information with the number of “3” in the recommendation information table G110 is 1.5 times. That is, the video content reproduction apparatus 1000 (the reproduction unit 120) can reproduce the recommendable content at the 1.5 times faster speed so that the recommendable content can be entirely reproduced within the remaining duration of 60 minutes.

The recommendable-content information display process is thus completed when the recommendation information image is displayed on the display device 400.

Hereinafter, information on recommendable content (video content not being reproduced) to be reproduced within a remaining duration is also referred to as shortened-video-content information.

Specifically, when the display device 400 displays a recommendable-content information item with a number of “3” shown in the recommendation information table G110, the display device 400 displays shortened-video-content information of the video content not being reproduced which has a duration longer than a remaining duration and is to be reproduced within the remaining duration.

In this case, the display control unit 170 included in the control unit 101 associates the shortened-video-content information and information indicating a reproduction speed to reproduce the video content not being reproduced within the remaining duration, and causes the display device 400 to display the shortened-video-content information and the information indicating a reproduction speed.

There may be the case where information on all the video content not being reproduced which can be reproduced by the reproduction unit 120 within a remaining duration is displayed as a result of searching performed in the recommendable-content search process. In this case, the control unit 101 causes the display device 400 to display the information on all the video content not being reproduced which can be reproduced by the reproduction unit 120 within the remaining duration.

The following describes a specific example. A user sets aside a content viewing time of two hours (120 minutes) and causes the video content reproduction apparatus 1000 to start reproduction of a video having a duration of two hours. Viewing the video having a duration of two hours, the user loses interest in the video 30 minutes after the start of the reproduction of the video and performs an information display instruction operation.

In this case, the user has a vacant time (an unoccupied time) of 1 hour and 30 minutes, which is obtained by subtracting 30 minutes from the content viewing time of two hours. Here, the vacant time (unoccupied time) equals a remaining duration.

Even in this case, as a result of the recommendable-content information display process, information on recommendable content (video) which suits a preference of the user is displayed on the display device 400 so that the user can use the vacant time (unoccupied time) well. In other words, displayed is recommendable-content information on recommendable content which is appropriate for the vacant time (unoccupied time). The user is thus provided with recommendable-content information on recommendable content appropriate for the vacant time (unoccupied time).

Then, the user can cause the video content reproduction apparatus 1000 to reproduce the recommendable content by performing a user operation M to start reproduction of recommendable content (video) corresponding to the recommendable-content information displayed on the display device 400. In this manner, even when a user has a vacant time (unoccupied time) in the middle of reproduction of video content, the user can still use the vacant time (unoccupied time) well.

The video content reproduction apparatus 1000 according to Embodiment 1 is thus capable of displaying information on a video which is different from a video content being reproduced and has an appropriate duration for a remaining duration of the unreproduced portion of the video content being reproduced.

In other words, the video content reproduction apparatus 1000 according to Embodiment 1 is capable of displaying information on a video appropriate for a duration of the unreproduced portion of a video that is being reproduced. Still in other words, the video content reproduction apparatus 1000 according to Embodiment 1 is capable of displaying information on a video appropriate for an unreproduced duration of a video that is being reproduced.

As a result, the user can have information on a video which is different from the video content being reproduced and has an appropriate duration for the remaining duration of the unreproduced portion of the video content being reproduced, so that usability is increased.

In the case where the duration of recommendable content which a user prefers is longer than a vacant time (unoccupied time) of the user, the user can still use the vacant time (unoccupied time) well by performing a user operation M to have the recommendable content reproduced at a reproduction speed according to the information on the reproduction speed.

In other words, the video content reproduction apparatus 1000 calculates a remaining duration and recommends a video appropriate for the remaining duration so that the user can view the video most appropriate for the remaining duration without complicated operation.

It is to be noted that the video content reproduction apparatus 1000 according to Embodiment 1 is not limited to the above configuration in which the video content reproduction apparatus 1000 includes the preference information storage unit 160 so that the video content reproduction apparatus 1000 is capable of recommending a video which suits a preference of a user better. The video content reproduction apparatus 1000 may not include the preference information storage unit 160. In this case, the recommendable content searched for is a video not associated with preference information but only appropriate for remaining duration.

When the video content reproduction apparatus 1000 does not have the preference information storage unit 160, the present invention produces an effect that the cost is reduced by non-volatile recording media for storing preference information, such as an HDD or an EEPROM.

In addition, the video content reproduction apparatus 1000 according to Embodiment 1 is not limited to the above configuration in which the information display instruction is transmitted to the instruction receiving unit 190 using the remote control unit 200. For example, a human body sensor may be used. In this case, the human body sensor detects presence of a user of the video content reproduction apparatus 1000, and an information display instruction is transmitted to the instruction receiving unit 190 when the user is no longer detected.

Optionally, a camera may be used. In this case, for example, a user's interest in content being reproduced is detected using a face detection technique, and an information display instruction is transmitted to the instruction receiving unit 190 when the interest is no longer detected. Such use of the human body sensor or the camera saves the user the trouble of operating the remote control unit 200. As a result, usability is further increased.

In addition, the video content reproduction apparatus 1000 according to Embodiment 1 is not limited to the above configuration in which a process for searching for recommendable content appropriate for a remaining duration calculated by the duration calculation unit 140. For example, the search unit 150 may be configured to search for a video having a duration not longer than a remaining duration and generate a recommendation information image showing a list of content information composed of a set of items of recommendable-content information so that a user can have the set of items of information as the recommendation information image displayed on the display device 400.

For example, when a remaining duration is 60 minutes, an information item on a video having a duration of 20 minutes and an information item on a video having a duration of 40 minutes are combined into a set of items of recommendable-content information. In this case, it is possible to provide a user with the recommendable-content information on video content having a duration of 60 minutes. Here, part of video content not being reproduced which corresponds to the set of the items of the recommendable-content information displayed on the display device 400 includes a plurality of videos.

Optionally, the search unit 150 may search for a video having a duration longer than a calculated remaining duration as described above. In this case, the display device 400 may show information on reproduction speed at which a corresponding video is entirely reproduced within the remaining duration.

For example, it is assumed that remaining duration is 60 minutes and that recommendable content having a duration of 90 minutes is found in the recommendable-content search process described above. When recommendable content is found, the user performs a user operation M using the remote control unit 200 in order to transmit an information display instruction so that the video content reproduction apparatus 1000 (the reproduction unit 120) reproduces the recommendable content at a reproduction speed 1.5 times faster than the original speed.

In this case, the whole of the recommendable content can be reproduced in the remaining duration of 60 minutes. As a result, the user may have more videos recommended than when only videos having duration not longer than remaining duration are searched for.

### Embodiment 2

Current time changes with time while the display device 400 displays a recommendation information image. Therefore, remaining duration also changes ceaselessly with the change in the current time.

In addition, a scheduled end time of a program may be changed due to extension of the program when the program belongs to the genre of, for example, baseball. That is, scheduled end times for a video that is being reproduced may be changed for some genres. In these cases, recommendable-content information shown in the recommendation information image in the process according to Embodiment 1 does not match the latest remaining duration.

In Embodiment 2, the following describes a process for updating recommendable-content information shown in a recommendation information image according to change in remaining duration.

A video content reproduction apparatus according to Embodiment 2 is the video content reproduction apparatus 1000 shown in FIG. 1. Therefore, the detailed description of the constituent elements of the video content reproduction apparatus 1000 is not repeated.

The following describes a process for displaying information on a video while another video is being reproduced (hereinafter referred to as a recommendable-content information display process A) according to Embodiment 2. The recommendable-content information display process A is performed while the reproduction unit 120 is reproducing a video.

Here, it is assumed that the video content reproduction apparatus 1000 is reproducing a video and a user is viewing the video displayed on the display device 400.

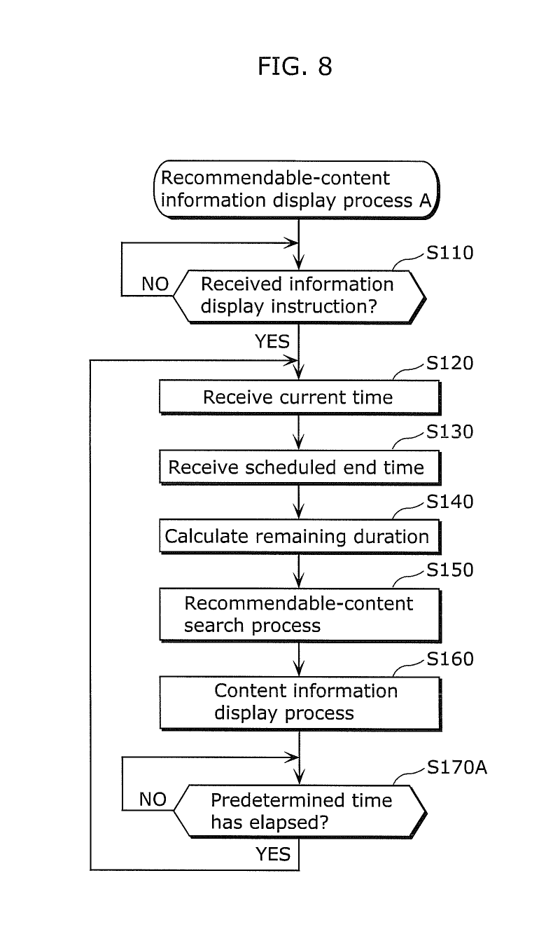

FIG. 8 is a flowchart of the recommendable-content information display process A. In FIG. 8, steps with step numbers also shown in FIG. 6 are performed in the same manner as described in Embodiment 1, and therefore the detailed description thereof is not repeated.

Step S110 to Step S160 are performed in the same manner as in Embodiment 1, and therefore the detailed description thereof is not repeated.

In Step S170A, the duration calculation unit 140 determines whether or not a predetermined time has elapsed since the latest completion of the process of Step S120. Here, for example, the predetermined time is one minutes. When Yes in Step S170A, the process proceeds to Step S120. On the other hand, when No in Step S170, the determining in Step S170A is performed again.

After the lapse of the predetermined time, the duration calculation unit 140 determines YES in Step S170A and the process of Step S120 is performed again.

That is, Step S140 in the recommendable-content information display process A is performed at an interval of the predetermined time. The duration calculation unit 140 thus calculates the latest remaining duration of the video that is being reproduced at an interval of the predetermined time while the video is being reproduced. In other words, the control unit 101 including the duration calculation unit 140 updates the remaining duration after video content being reproduced has been reproduced by the reproduction unit 120 for a predetermined time.

In addition, Step S150 in the recommendable-content information display process A is performed at an interval of the predetermined time. Then, recommendable content appropriate for the remaining duration calculated based on the latest current time is searched for.

In addition, Step S160 in the recommendable-content information display process A is performed at an interval of the predetermined time. Then, the display control unit 170 causes the display device 400 to display a recommendation information image showing recommendable-content information appropriate for the latest remaining duration each time the latest remaining duration is calculated.

In other words, the display control unit 170 thereby causes the display device 400 to display information on another video which has an appropriate duration for the latest remaining duration each time the latest remaining duration is calculated. Specifically, when the instruction receiving unit 190 receives an information display instruction, the control unit 101 including the display control unit 170 causes the display device 400 to display information on video content not being reproduced which is all or part of the video content not being reproduced and can be reproduced by the reproduction unit 120 within the updated remaining duration of the video content being reproduced.

That is, the recommendable-content information display process A is performed so that a recommendation information image is displayed and subsequently updated at an interval of the predetermined time to show recommendable-content information corresponding to the latest remaining duration.

As described above, according to Embodiment 2, remaining duration is repeatedly calculated to adapt it to the current time and a recommendation information image is dynamically updated. Then, the display device 400 displays the recommendation information image showing recommendable-content information appropriate for the latest remaining duration. This allows a user to refer to the latest recommendable-content information and cause the video content reproduction apparatus 1000 to reproduce a preferable video. As a result, usability is further increased.

In the case where the recommendable content is defined such that an appropriate duration for a remaining duration is not longer than the remaining duration, it is possible to avoid recommending a video having a duration longer than the remaining duration.

It is to be noted that the present invention is not limited to the above description of Embodiment 1 or Embodiment 2 in which the video content being reproduced is a video that is being reproduced by the video content reproduction apparatus 1000 (the reproduction unit 120).

For example, the display device 400 may receive a broadcast stream and reproduce a video included in the broadcast stream. In other words, in Embodiment 1 and Embodiment 2, the video content being reproduced may be a video that is being reproduced by the display device 400. In this case, the display device 400 transmits program information corresponding to the video which the display device 400 is reproducing (for example, the program information T201 in FIG. 2) to the video content reproduction apparatus 1000.

The video content reproduction apparatus 1000 uses the program information to identify the video which the display device 400 is reproducing and obtains the broadcasting time for the video. In this case, the video content reproduction apparatus 1000 may perform the recommendable-content information display process shown in FIG. 6 or the recommendable-content information display process A shown in FIG. 8 with reference to the program information (including broadcasting time) received from the display device 400, while the display device 400 is reproducing the video.

In other words, the video content reproduction apparatus 1000 may perform calculation of a remaining duration (S140), recommendable-content information display process (S160), and so on with reference to program information of the video which the display device 400 is reproducing. Here, when the instruction receiving unit 190 receives an information display instruction to display information on a video that is not being reproduced (hereinafter referred to as video content not being reproduced) which is different from the video that is being reproduced by the display device 400 (hereinafter referred to as video content being reproduced), the control unit 101 causes the display device 400 to display information on video content not being reproduced which is all or part of the video content not being reproduced and can be reproduced by the reproduction unit 120 within the duration of the unreproduced portion of the video content being reproduced (hereinafter referred to as a remaining duration).

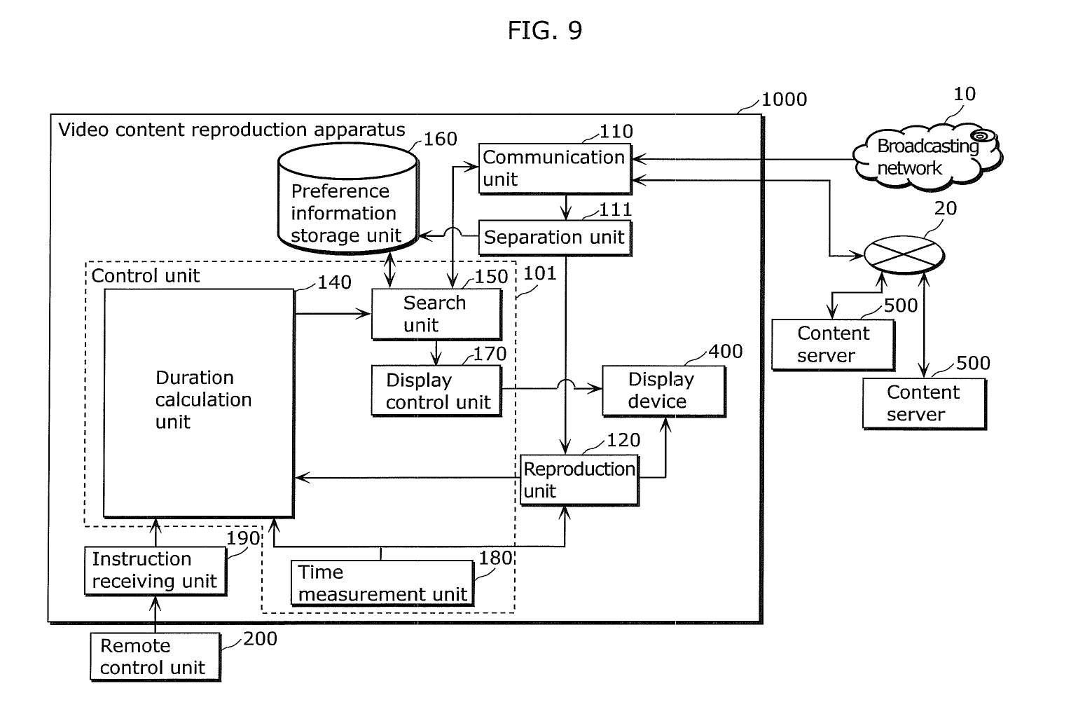

The video content reproduction apparatus 1000 may include the display device 400 as described above. In this case, the video content reproduction apparatus 1000 is in a configuration as shown in FIG. 9. In this case, the video content reproduction apparatus 1000 may be a device such as a television receiver, a mobile phone, or a tablet terminal. The display device 400 included in the video content reproduction apparatus 1000 is a display unit which displays a video.

The video content reproduction apparatus 1000 in the configuration shown in FIG. 9 performs the processes as described in Embodiment 1 and Embodiment 2, and therefore the detailed description thereof is not repeated.

(Functional Block Diagram)

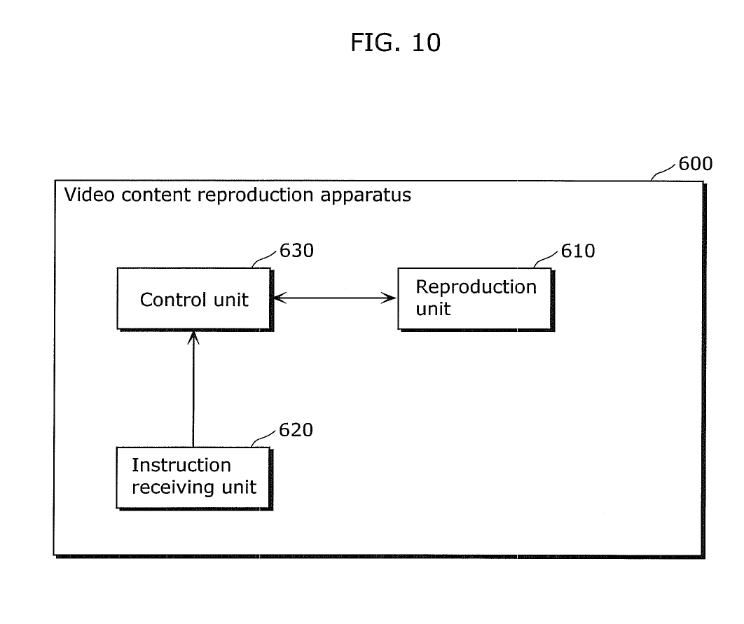

FIG. 10 is a block diagram illustrating a functional configuration characteristic to a video content reproduction apparatus 600. The video content reproduction apparatus 600 corresponds to the video content reproduction apparatus 1000. FIG. 10 is therefore a block diagram illustrating major functions related to the present invention included in the functions of the video content reproduction apparatus 1000.

The video content reproduction apparatus 600 operates in conjunction with a display device not shown in the drawing. The display device corresponds to, for example, the display device 400 shown in FIG. 1 or FIG. 9. The display device may be reproducing a video.

The video content reproduction apparatus 600 includes functional units of a reproduction unit 610, an instruction receiving unit 620, and a control unit 630.

The reproduction unit 610 reproduces a video. The reproduction unit 610 corresponds to the reproduction unit 120 in FIG. 1. Hereinafter, a video that is being reproduced is also referred to as video content being reproduced. Hereinafter, a video that is different from the video content being reproduced is also referred to as video content not being reproduced. Hereinafter, a duration of an unreproduced portion of video content being reproduced is also referred to as a remaining duration.

The instruction receiving unit 620 receives an instruction. Specifically, the instruction receiving unit 620 receives an information display instruction to display information on video content that is not being reproduced, that is, a video different from a video that is being reproduced (video content being reproduced). The instruction receiving unit 620 corresponds to the instruction receiving unit 190.

The control unit 630 controls the video content reproduction apparatus 600.

When the instruction receiving unit 620 receives an information display instruction, the control unit 630 causes the display device to display information on video content not being reproduced which is all or part of the video content not being reproduced and can be reproduced by the reproduction unit 610 within the duration of the unreproduced portion of the video content being reproduced (remaining duration). The control unit 630 corresponds to the control unit 101.

All or part of the reproduction unit 610, the instruction receiving unit 620, and the control unit 630 included in the video content reproduction apparatus 600 may be implemented in hardware such as a large scale integration (LSI).

Furthermore, all or part of the reproduction unit 610, the instruction receiving unit 620, and the control unit 630 included in the video content reproduction apparatus 600 may be a module of a program to be executed by a processor such as a CPU.

The video content reproduction apparatus 1000 according to the present invention has been described above based on Embodiment 1 and Embodiment 2 above but is not limited to Embodiment 1 or Embodiment 2. The present invention also includes variations of Embodiment 1 or Embodiment 2 to be conceived by those skilled in the art and embodiments where the constituent elements in Embodiment 1 and Embodiment 2 are used in any combination unless they depart from the spirit and scope of the present invention.

In addition, all or part of the constituent elements included in the video content reproduction apparatus 1000 may be implemented in hardware. Furthermore, all or part of the constituent elements included in the video content reproduction apparatus 1000 may be a module of a program to be executed by a central processing unit (CPU) or the like.

All or part of the constituent elements included in the video content reproduction apparatus 1000 may be implemented as a single system large scale integration (LSI). A system LSI is a super-multifunctional LSI manufactured by integrating a plurality of components on a chip. Specifically, a system LSI is a computer system including components such as a microprocessor, a read-only memory (ROM), and a random-access memory (RAM).

For example, the communication unit 110, the separation unit 111, the reproduction unit 120, the duration calculation unit 140, the search unit 150, the display control unit 170, the time measurement unit 180, and the instruction receiving unit 190 in FIG. 1 may be implemented as a single system LSI.

The present invention may also be implemented as a method of displaying content information in which the operations of the component units characteristic to the video content reproduction apparatus 1000 are included as steps. The present invention may also be implemented as a program which causes a computer to execute the steps included in the method of displaying content information. The present invention may also be implemented as a computer-readable recording medium on which the program is recorded. The program may also be distributed through a transmission medium such as the Internet.

The embodiments disclosed herein are exemplary in all respects and should never be considered limiting. The scope of the present invention is indicated not by the description above but by the claims, and is intended to include any modification within the scope and the sense of equivalents of the claims.

### INDUSTRIAL APPLICABILITY

The present invention is applicable as a video content reproduction apparatus which is capable of displaying information on a video appropriate for the duration of the unreproduced portion of a video that is being reproduced.

### REFERENCE SIGNS LIST

101, 630 Control unit
110 Communication unit
111 Separation unit
120, 610 Reproduction unit
140 Duration calculation unit
150 Search unit
160 Preference information storage unit
170 Display control unit
180 Time measurement unit
190, 620 Instruction receiving unit
200 Remote control unit
400 Display device
500 Content server
600, 1000 Video content reproduction apparatus

1. A video content reproduction apparatus which operates in conjunction with a display device, said video content reproduction apparatus comprising:
a reproduction unit configured to reproduce a video;
an instruction receiving unit configured to receive an instruction; and
a control unit configured to control said video content reproduction apparatus,
wherein, when said instruction receiving unit receives an information display instruction to display information on a video that is not being reproduced (hereinafter referred to as video content not being reproduced) which is a video different from a video that is being reproduced (hereinafter referred to as video content being reproduced), said control unit is configured to cause the display device to display information on video content not being reproduced which is all or part of the video content not being reproduced and can be reproduced by said reproduction unit within a remaining duration of the video content being reproduced, the remaining duration being a duration of an unreproduced portion of the video content being reproduced.

2. The video content reproduction apparatus according to claim 1,
wherein, when said instruction receiving unit receives the information display instruction, said control unit is configured to search in information on the video content not being reproduced for information on video content not being reproduced which has a duration not longer than the remaining duration, and cause the display device to display the information obtained by the searching.

3. The video content reproduction apparatus according to claim 2,
wherein the information obtained by said control unit by searching in the information on the video content not being reproduced is information on video content not being reproduced which has a duration not longer than the remaining duration and suits a preference of a user.

4. The video content reproduction apparatus according to claim 1,
wherein, when said control unit causes the display device to display the information on video content not being reproduced and the video content not being reproduced is to be entirely reproduced within the remaining duration and has a duration longer than the remaining duration (hereinafter the information is referred to as shortened-video-content information), said control unit is configured to associate the shortened-video-content information with information on a reproduction speed at which the video content not being reproduced is entirely reproduced within the remaining duration, and cause the display device to display the shortened-video-content information and the information on the reproduction speed.

5. The video content reproduction apparatus according to claim 1,
wherein said control unit is configured to update the remaining duration after the video content being reproduced has been reproduced by said reproduction unit for a predetermined time, and
when said instruction receiving unit receives the information display instruction, said control unit is configured to cause the display device to display information on video content not being reproduced which is all or part of all the video content not being reproduced and can be reproduced by said reproduction unit within the updated remaining duration of the video content being reproduced.

6. The video content reproduction apparatus according to claim 1,
wherein the part of the video content not being reproduced includes a plurality of videos.

7. A video content reproduction apparatus which operates in conjunction with a display device which reproduces a video, said video content reproduction apparatus comprising:
a reproduction unit configured to reproduce a video;
an instruction receiving unit configured to receive an instruction; and
a control unit configured to control said video content reproduction apparatus,
wherein, when said instruction receiving unit receives an information display instruction to display information on a video that is not being reproduced (hereinafter referred to as video content not being reproduced) which is a video different from a video that is being reproduced by the display device (hereinafter referred to as video content being reproduced), said control unit is configured to cause the display device to display information on video content not being reproduced which is all or part of the video content not being reproduced and can be reproduced by said reproduction unit within a remaining duration of the video content being reproduced, the remaining duration being a duration of an unreproduced portion of the video content being reproduced.

8. A video content reproduction apparatus comprising:
a display unit configured to display a video;
a reproduction unit configured to reproduce a video;
an instruction receiving unit configured to receive an instruction; and
a control unit configured to control said video content reproduction apparatus,
wherein, when said instruction receiving unit receives an information display instruction to display information on a video that is not being reproduced (hereinafter referred to as video content not being reproduced) which is a video different from a video that is being reproduced (hereinafter referred to as video content being reproduced), said control unit is configured to cause said display unit to display information on video content not being reproduced which is all or part of the video content not being reproduced and can be reproduced by said reproduction unit within a remaining duration of the video content being reproduced, the remaining duration being a duration of an unreproduced portion of the video content being reproduced.

9. A method of displaying video content performed by a reproduction apparatus which operates in conjunction with a display device,
the video content reproduction apparatus including:
a reproduction unit configured to reproduce a video; and
an instruction receiving unit configured to receive an instruction, and said method comprising:
when the instruction receiving unit receives an information display instruction to display information on a video that is not being reproduced (hereinafter referred to as video content not being reproduced) which is a video different from a video that is being reproduced (hereinafter referred to as video content being reproduced), causing the display device to display information on video content not being reproduced which is all or part of the video content not being reproduced and can be reproduced by the reproduction unit within a remaining duration of the video content being reproduced, the remaining duration being a duration of an unreproduced portion of the video content being reproduced.
